(19) United States
(12) Patent Application Publication
(10) Pub. No.: US 2015/0149286 A1
(43) Pub. Date: May 28, 2015

(54) MOBILE PROVIDER ADVERTISING AND SCHEDULING PLATFORM

(71) Applicant: Benjamin Alexander Brown, II, Vero Beach, FL (US)

(72) Inventor: Benjamin Alexander Brown, II, Vero Beach, FL (US)

(73) Assignee: Benjamin Alexander Brown, II, Vero Beach, FL (US)

(21) Appl. No.: 14/089,884

(22) Filed: Nov. 26, 2013

(51) Int. Cl. G06Q 30/02

(52) U.S. Cl. CPC G06Q 30/0264; G06Q 30/0261; G06Q 30/0267
USPC 705/14.58

(57) ABSTRACT

Systems and methods for matching consumers with providers are provided. A method includes obtaining scheduling information and provider information associated with providers, the scheduling information comprising availability information and location information associated with each of the providers for different time blocks, and the provider information including goods or services information associated with each of the providers. The method also includes receiving a query associated with a consumer specifying a good or service to be provided to the consumer and a requested location for the providing. The method also includes generating, based on the scheduling information, a response to the query. The response can include an identification of providers available to provide the good or the service at the location and times each of the identified providers is available to provide the good or the service at the location.

### FIELD OF THE INVENTION

The present invention relates to matching of providers of goods or service to consumers, and more specifically to apparatus and methods for matching of providers of goods or service to consumers using a mobile provider advertising and scheduling platform.

### BACKGROUND

In general, the provision of goods and services to consumers by providers at the consumer's location is carried out based on a brick and mortar storefront model. That is, the consumer contacts a central location associated with a provider servicing the consumer's location, interacts with a person or scheduling system at the central location to select a time in the future for the provision of the goods or services, and the central location then dispatches an agent to the consumer's location at the agreed upon time to provide the goods and services. While such approaches work well for large organizations with abundant resources, such approaches are not suitable for smaller provider organizations, solo providers, or providers whose time and location is temporary or varies over time.

For example, in the case of smaller provider organizations or solo providers, even though they may service a relatively large geographic area, they generally have few resources to effectively cover the geographic area at all times. As a result, smaller provider organizations and solo providers typically rely on relatively large time windows for appointments to ensure sufficient time to complete a service or delivery of goods to a consumer and travel to a next appointment. Unfortunately, this also means that if all time windows are not scheduled, the small provider organization or solo provider may be faced with a significant amount of time when his resources are idled. Additionally, this also results in a large amount of travel time and fewer customers for such provider organization and solo providers. As a result, scheduling for such smaller organizations and solo providers is typically inefficient.

Moreover, in the case of providers whose time of availability or location is temporary, there is not provided an effective means of providing advertising for such providers. In general, most advertising is still based on the brick and mortar model. That is, an advertisement must be placed in significant advance of the time of availability of the provider at a location. Thus, providers that temporarily “pop-up” to provide goods and services at a location (e.g., a charity car wash or a farmer fruit/vegetable stand) cannot generally obtain on-the-fly advertising and have to rely on the number and interest of persons passing by for their event to be successful. Additionally, in the case of smaller provider organization or solo providers that operate out of a vehicle or other mobile location and have open windows of time, there is no effective way to provide advertising of their goods and services in their current location.

### SUMMARY

Embodiments of the invention concern systems and methods for matching of providers of goods or service to consumers, and more specifically to apparatus and methods for matching of providers of goods or service to consumers using a mobile provider advertising and scheduling platform. In a first embodiment of the invention, there is provided a method. The method includes obtaining scheduling information and provider information associated with one or more providers, the scheduling information including availability information and location information associated with each of the providers for at least a portion of a plurality of time blocks, and the provider information including at least one of goods information or services information or event information associated with each of the providers. The method also includes receiving a query associated with a consumer specifying at least one of a good or service or event to be provided to the consumer and a requested location for the providing of at least one of the good or service or event. The method further includes generating, based on the scheduling information, a response to the query. The response includes an identification of a portion of the providers available to provide the good or the service at the location to yield identified providers, and one or more times each of the identified providers is available to provide the good or the service or event at the location to yield identified times.

The method can also include receiving, from a consumer user terminal associated with the consumer, a selection of one of the identified providers and one of the identified times associated with the one of the identified providers, updating the scheduling information for the identified provider based on the received selection, and generating a message for a provider user terminal associated with the identified provider, the message indicating a booking of the identified provider at the one of the identified times. The method can also include delivering to the first user terminal instructions for providing a payment required by the provider for confirming the booking based on the selection, and wherein the generating of the message is performed once receipt of the payment occurs.

In the method, at least one of the goods information or the service information or event information is associated with a particular one of the plurality of the time blocks.

In the method, the generating of the response further includes ranking the identified providers according to pre-defined criteria. The pre-defined criteria can be based on at least one of relative proximity to the requested location, a booking frequency associated with the identified providers, user ratings associated the identified providers, cost ratings associated with the identified providers, and type of the identified providers.

In the method, the receiving can include obtaining a query from a search engine being accessed by the consumer via a consumer terminal. Further, at least a portion of the query is based on cookie information associated with the consumer terminal.

In the method, at least a portion of the query is based on geo-location data stored at a consumer terminal associated with the consumer.

In a second embodiment of the invention there is provided a computer-readable medium for carrying out the various steps in the method of the first embodiment.

In a third embodiment of the invention, a system is provided. The system includes a memory for storing scheduling information and provider information associated with one or more providers, the scheduling information including availability information and location information associated with each of the providers for at least a portion of a plurality of time blocks, and the provider information including at least one of goods information or services information associated with each of the providers. The system also includes at least one processor communicatively coupled to the memory. The system also includes a computer-readable medium having stored thereon a plurality of code sections for causing the at least one processor to perform steps. The steps include receiving a query associated with a consumer specifying at least one of a good or service to be provided to the consumer and a requested location for the providing of the at least one of the good or service, and generating, based on the scheduling information, a response to the query. The response includes an identification of a portion of the providers available to provide the good or the service at the location to yield identified providers, and one or more times each of the identified providers is available to provide the good or the service at the location to yield identified times.

The method can also include receiving, from a consumer user terminal associated with the consumer, a selection of one of the identified providers and one of the identified times associated with the one of the identified providers, updating the scheduling information for the identified provider based on the received selection, and generating a message for a provider user terminal associated with the identified provider, the message indicating a booking of the identified provider at the one of the identified times. The method can also include delivering to the first user terminal instructions for providing a payment required by the provider for confirming the booking based on the selection, and wherein the generating of the message is performed once receipt of the payment occurs.

In the system, at least one of the goods information and the service information is associated with particular one of the plurality of time blocks.

In the system, the generating of the response further includes ranking the identified providers according to pre-defined criteria. The pre-defined criteria can be based on at least one of relative proximity to the requested location, a booking frequency associated the identified providers, user ratings associated the identified providers, cost ratings associated with the identified providers, and a type of the identified providers.

In the system, the receiving can include obtaining a query from a search engine being accessed by the consumer via a consumer terminal. Further, at least a portion of the query is based on cookie information associated with the consumer terminal.

In the system, at least a portion of the query is based on geo-location data stored at a consumer terminal associated with the consumer.

### BRIEF DESCRIPTION OF THE DRAWINGS

FIGS. 1A and 1B illustrate a general framework for a platform in accordance with the various embodiments;

FIG. 2 shows a computing system for implementing aspects of the various embodiments;

FIG. 3, which illustrates an exemplary system configuration 300, wherein electronic devices communicate via a network for purposes of exchanging content and other data in accordance with the various embodiments; and

FIG. 4 is a flow chart of steps in an exemplary method 400 for processing queries in accordance with the various embodiments.

### DETAILED DESCRIPTION

The present invention is described with reference to the attached figures, wherein like reference numerals are used throughout the figures to designate similar or equivalent elements. The figures are not drawn to scale and they are provided merely to illustrate the instant invention. Several aspects of the invention are described below with reference to example applications for illustration. It should be understood that numerous specific details, relationships, and methods are set forth to provide a full understanding of the invention. One having ordinary skill in the relevant art, however, will readily recognize that the invention can be practiced without one or more of the specific details or with other methods. In other instances, well-known structures or operations are not shown in detail to avoid obscuring the invention. The present invention is not limited by the illustrated ordering of acts or events, as some acts may occur in different orders and/or concurrently with other acts or events. Furthermore, not all illustrated acts or events are required to implement a methodology in accordance with the present invention.

Search engines index information. Traditionally search engines have indexed information that has been presented using the Hypertext Markup Language (HTML). In the last few years, a significant new source of unstructured information has emerged in the form of social media. Search engines have begun to index this information too. The commonality is that both sources of information are largely unstructured from a semantic standpoint. This invention contemplates utilizing API's that extend HTML with the principles of HTML5 as defined by the W3C and/or WHATWG; more specifically, the separate emerging standards for metadata known as Microdata. It is contemplated that the majority of the data created by this invention will be structured in a semantic vocabulary utilizing schema.org or custom defined vocabularies in order to index mobile devices, their users, their location, their schedules, and their availability to provide various types of services, goods, and events in order to create more efficient marketplaces for commerce. The purpose of the present invention is to index services that by their very nature are transient or temporal in nature. Most significantly, the invention relies on the relationship between a service provider's availability and/or schedule to give context to the provision of goods, services, or events. This is not merely structuring and communicating set business hours, it is communicating real-time availability for specific services, goods, and/or events. The current scheme of indexing information largely delivers potential availability for the provision of services; this invention contemplates actual availability only enabled by the proactive communication of service providers. Service providers today are limited to vague and inaccurate HTML pages, social media, physical brick and mortar advertising, signage or traditional media. None of the aforementioned methods of advertising services, goods, or events can allow for procurement in such an efficient or accurate way because the advertising does not coincide with actual availability in all cases; existing methods offer potential availability; this invention contemplates actual availability by allowing service providers, sellers of goods and/or event planners to communicate what they have to offer real-time, as opposed to what they might have to offer. In this respect, the invention represents a dynamic set of data that changes as fast as the pace of business, leaving other data sources obsolete by their nature.

While the services and applications discussed herein may coincide or be associated with retail locations, the various embodiments are directed to the provisioning of services and events that are independent of fixed brick and mortar locations and fixed retail hours. Instead, the various embodiments are directed to the concept of on-demand, real time commerce, enabled by mobile devices with location based services. Thus, the present disclosure contemplates a platform that will facilitate real time commerce between service providers, offering their services, goods and events, to end users.

As noted above, smartphones and mobile devices are portable computers enhanced with location-based services. Therefore, with a web application or application installed onto the mobile device, a service provider has a non-HTML specific (although the service can present it in HTML to end users, etc.) mechanism for communicating who they are, their services, their location, and their availability (now or in the future via calendar). Thus, a platform in accordance with the various embodiments permits a small business or independent contractor to avoid the need to hire a web developer to build a website, hire an internet marketing firm to conduct search engine optimization to get the search engine to index the HTML and rank the site higher. Instead, all the service provider has to do is provide their information to the platform via an application on their mobile device and the structured information feed will be broadcast over the platform. Thereafter, the service provider can be located by end users based upon user defined criteria, including, but not limited to: the service provided, proximity to the job/event location, immediate availability (or future schedule), history (background, experience), reviews, etc.

The present disclosure also contemplates enhancing the traditional search engine paradigm. In the traditional search engine paradigm, key word rich content and social media drive HTML based web pages to rank towards the top, giving the small business (if they can afford to pay a web designer, an internet marketing firm, and a social marketing firm) an opportunity to be visible to end users searching for their services. Further, some search engines have begun indexing retail based locations and serving those results to end users based upon location. However, there is no search result that shows the existence of the mobile service provider.

Current search engines index HTML web pages based upon complex algorithms and can index retail locations in proximity to the search and even rank those with social media information higher still. However, they generally do not index transient services, goods, or events in real-time based upon the location and real-time schedule/availability of the service providers. This difference is significant for both end users and service providers.

For example, if an end user searches for a car wash at 9 AM on Saturday morning from his location. Traditional search engines will report that there is retail based car wash three (3) miles from the location and that it is that is open until noon on Saturday. The information is marginally more informative than a telephone book ad from 1990. In contrast, a platform in accordance with the various embodiments can supplement such search results to provide real-time information, including availability information for such service providers. In particular, the service platform can be configured to provide search results that will report that there is a mobile car detailing service that is at a building across the street from your current location. Further, the results can also indicate that the detailing service will be available in 10 minutes. The results can also tell you that there is another mobile car detailer who is 2 miles away and is currently occupied, but will be available at 9:45 AM.

Such a platform can also be configured to allow a service provider with one or more mobile elements to manage the elements as needed. For example, the manager of a mobile car wash service can toggle the availability status of elements or services. That is, if a major mechanical issue with equipment or transport prevents a mobile element from providing car wash services and they need to close early, it is not worth updating the website or the search engine's local listing for users to obtain such information. However, with this real time platform, users can gleam this type information in a real-time manner. That is the difference between a platform designed to index and search largely static reference information and a platform, such as that of the various embodiments, which is specifically designed to index real-time, location and availability based information provided directly through an application.

Unlike a traditional search engine, “content” is only necessary to the extent necessary to describe the services, goods and/or events which the service provider intends to offer; that means all the traditional expense of web site design and internet marketing is moot. Further unlike traditional search engines, which largely look at factors such as content, key words, traffic (and therefore authority), social media presence, fixed retail bricks and mortar addresses, etc., a platform in accordance with the various embodiments is the marketing mechanism.

In the various embodiments, the service providers will rank highest based on completely different factors than the traditional search engine results. The primary factors in the ranking algorithm for this platform are service (match), location (proximity) to the end user, and real-time availability (or future scheduled). There can also be secondary factors, such as reviews, service provider background information, and service provider experience in a particular field or with respect to particular goods and services.

Thus, a platform in accordance with the various embodiments creates a new source of information: the location and availability of transient services, goods and events. By indexing this information, it is possible to: (1) create more efficient markets for existing service providers and users to transact business, and (2) create new markets for services that can only exist with the efficiency of such real-time information. This, ad hoc demand for services is met with ad hoc provision of services to create transactions that otherwise would never have taken place in a traditional brick and mortar model.

Overview of the Platform

As described above, the various embodiments are directed to matching end users and mobile service providers, based upon real-time location (proximity) and availability. Local service providers create a profile with the platform describing, for example, the services offered, rates for services (can be optional in some circumstances), education/experience information, and, optionally, background investigation results. However, the various embodiments are not limited to solely such profile information and any other type of profile information can be utilized in the various embodiments. Service providers communicate their availability to offer the service by indicating whether or not they are available on their mobile device. Optionally, for a fee in some embodiments, service providers can share their calendar and future availability.

End users can then search for services on the platform and see a list of service providers that match, when the service provider is available to provide the service, their distance to the user or location for services, and any other information relevant to the users. In some embodiments, a default search configuration can be provided. In other embodiments, the search can be partially or completely customized by the end user. End users can then book the service provider. Alternatively, the platform can be configured to allow users to communicate, via the platform, with a service provider from the search results to allow the end user to exchange additional information with the service provider or to communicate instructions to the service provider.

In response to the selection, the service provider can manually or automatically accept or schedule booking for the requested service. Once the service provider has rendered the service, the service provider can optionally use the platform, via his mobile device, to receive or confirm electronic payment from the end user. In such a configuration, the platform can provide mobile payment services or can integrate the platform with one or more an existing mobile payment providers.

After payment has been made, the end user can be sent a receipt and, optionally, a request for providing a review of the service provider. In some embodiments, this can be configured to be the only mechanism for service providers to receive reviews on the platform. However, in other embodiments, alternate means for providing a review can be provided.

Regardless of whether a user posts a review of the experience, the service provider can gain, in some embodiments, an experience rating from having successfully rendered a service and accepted payment via the platform. This experience rating can be integrated into an algorithm that ranks the results for end user searches or can be used by end users during a customized search. In either case, the search results for the end user can be configured, in some embodiments, to provide a preference to those service providers with higher experience ratings.

In addition to providing end users with a non-cash based method for providing payment to service providers (and therefore more secure), the payment and review features of the platform of the various embodiments can provide end users increased consumer protection by being able to post reviews and/or dispute credit card charges. In some embodiments, the platform can be configured to allow end users to create an account on the platform for payment and therefore a physical credit card will not necessarily be required to transact business onsite. Thus, the transaction can be made even more secure. Such a payment platform is a benefit to both end users and service providers. In some embodiments, the payment platform can provide source of revenue to be split with payment providers and the platform, either via transaction fees, subscription fees, or both.

In the various embodiments, by tying payment and experience ratings through the platform, end users and service providers are dissuaded from bypassing the platform. In particular, if service providers bypass the platform, no experience points would be awarded, thus lowering the ranking of service providers in end user queries. If end users bypass the platform, end users thus surrender their ability to resolve disputes via the platform.

An advantage of the platform described above is that it fits in with the dynamics of Generation Y. Generation Y is the largest generation to date, is generally savvy with respect to the use of smartphones and other mobile devices, and is predicted by demographers to create hundreds of thousands, if not millions, of new businesses. In looking at the struggles of startup businesses and independent contractors, particularly those in Generation Y, a universal problem is cost of effective advertising and marketing, compounded by the lack of intellectual and financial capital that many of these startups have. The various embodiments therefore leverage the existing technology investments that many independent contractors/businesses in Generation Y already own, a smartphone, in order to market their businesses in a cost effective manner. Therefore, in addition to efficiently advertising service availability, the platform of the various embodiments offers a method to securely transact business with users (especially those in Generation Y) and the ability to build an experience rating, translating to credibility. Although Generation Y is a prime target demographic group, any service provider with additional capacity in his or her schedule will be able to utilize the platform.

In view of the foregoing, the various embodiments of the invention allow independent businesses to reduce or eliminate the expense of web advertising or traditional media by utilizing a platform that advertises their services, their experience, and their availability. In some cases, the platform can provide such services for free or for fees. In some configurations, fees can escalate with the amount of services being provided. For example, a basic account with limited capabilities can be provided for free. A more advanced account can be provided for small monthly fee and/or transaction fees. The fees can allow the service provider to have advanced scheduling capabilities, advanced payment options, and/or additional features to allow the service provider to turn a smartphone or other mobile device into a fully-featured scheduling and payment hub for their business.

In the various embodiments, existing marketplaces of providers of goods and services, having critical masses of users, can augment or replace existing web sites or other conventional advertising formats, with the platform. Some of these providers include, but are not limited to, providers for general services (e.g., construction, lawn care, car washing, and handymen services), courier services, independent transportation services, caregiving services (e.g., childcare, elderly care, and nursing care), and professional services (e.g., legal, accounting, and information technology services). Such providers would be able leverage the platform to supplement and enhance their existing marketplaces with the data feed from the platform. For example, a provider of caregiving services would be able to offer an “available now” set of search results to offer end users looking for a last minute care provider; alternatively, standard provider listings could be augmented with a simple icon or other visual indication that the provider is “available now.” In the same way, other service marketplaces will be able to offer a data stream of real-time (and scheduled) services to supplement the static listings offered on their sites.

In some embodiments, the platform will be licensed and branded on behalf of the platform provider and an application will be installed and used by the service providers on their mobile devices to advertise and offer services to end users. As noted above, many of the existing marketplaces amount to little more than static service provider advertising and reviews and offer little benefit to service providers beyond that. The platform will enable the platform provider managing the platform to offer associated service providers a branded, real-time advertising and transactional platform. Therefore, platform providers can offer service providers a competitive advantage over other advertising and listing services, which provides the service providers the ability to accurately communicate their schedule and availability information through a trusted and professional platform. Thus, service providers can conveniently pick up last minute jobs that might otherwise not be available. In short, it offers service providers a mechanism to advertise their real-time availability, which amounts to real-time advertising and opens up the possibility of real-time transactions.

It should be noted that despite the listing of well-known types of service providers listed above, anyone could be a service provider and utilize the various embodiments of the invention. For example, in addition to the service providers listed above, other potential service providers include 7 year old girls selling lemonade at a stand in their neighborhood (with Mom helping out of course), the college student working part-time as a courier or delivery person, the makeup artist who wants to offer face painting at the festival in the park, and the management consultant in town with a couple of days of free time looking for new clients. In general, these and other parties can utilize the platform of the various embodiments.

As a result, the platform has the ability to change the way people think about the provision of services, goods, and events. That is, the various embodiments can allow business to be transacted anytime, anywhere, and by any type of service provider with a degree of effectiveness that is not present with today's information platforms. Therefore, any service provider can take his/her services, skills and experience with them, wherever they go. For example, not everything that we want to buy is found in a store or restaurant, such as mobile food trucks, impromptu roadside stands, festivals, concerts, and estate sales. Because of the transient or temporary nature of such events, the conventional advertising model fails. The conventional way of advertising events is to publish it in the paper, the newspaper's website, other local websites, flyers, etc. and now through social media. In contrast, the platform of the various embodiments allows a provider to broadcast information about goods and services available, in real-time and from any location. Such providers need only list their goods and services, their location, and associated fees. Optionally, users can make payment directly on the platform and obtain the goods or services promised upon arrival of the end user at the location. For example in the case of events such as a festival or concert, the scheduled location is broadcast and tickets can then be sold in advance. In addition, the day of the event, people looking for things to do can find the event.

Additionally, the platform of the various embodiments can address some of the limitations of certain types of services providers. That is, some types of service providers may have a business address that fails to reflect the actual location of the service provider. Even worse, the business address may always be in the same place, but its presence is transient. For example, a boat captain on the docks of Key West may obtain customers by placing a kiosk on the docks during certain times of the day. However, many search providers will not accept the kiosk as a legitimate business location, even though it is operationally a real location. The platform of the various embodiments thus allows the boat captain to update his availability and location in real-time. Thus, potential clients see the locations and availability of the boats for rent in real-time.

It should be noted that although the platform of the various embodiments is presented herein as an alternative to traditional advertising methods, the platform can also serve to supplement traditional these methods for service, goods and event advertising in order to maximize revenue. Not every user plans every transaction well in advance and many transactions are last minute. Accordingly, by providing a service platform for service providers to offer goods and services in real-time and on an ad hoc basis, last minute transactions will be facilitated more than previously possible via existing advertising methods. In much the way that social media has made it possible to stay in touch with more friends and acquaintances where it were otherwise unfeasible, this platform allows end users access to a whole world of non-retail specific service providers that otherwise have minimal or no online presence. By the same token, more people will offer their services if they are provided with a cost effective, efficient way to advertise and provide those services, when and where they want to.

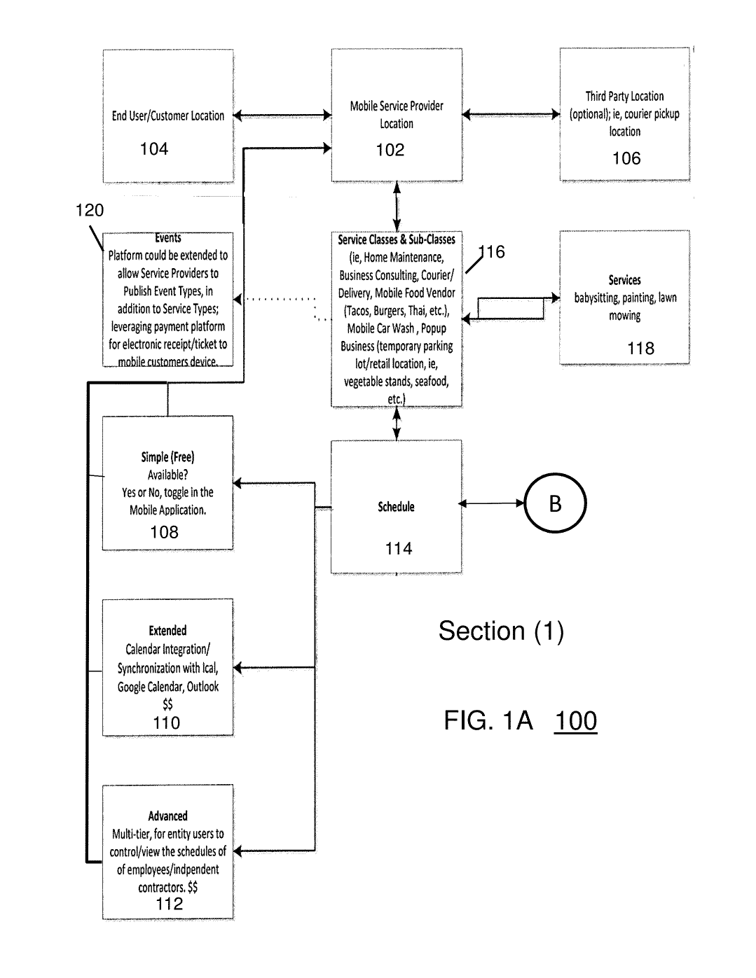

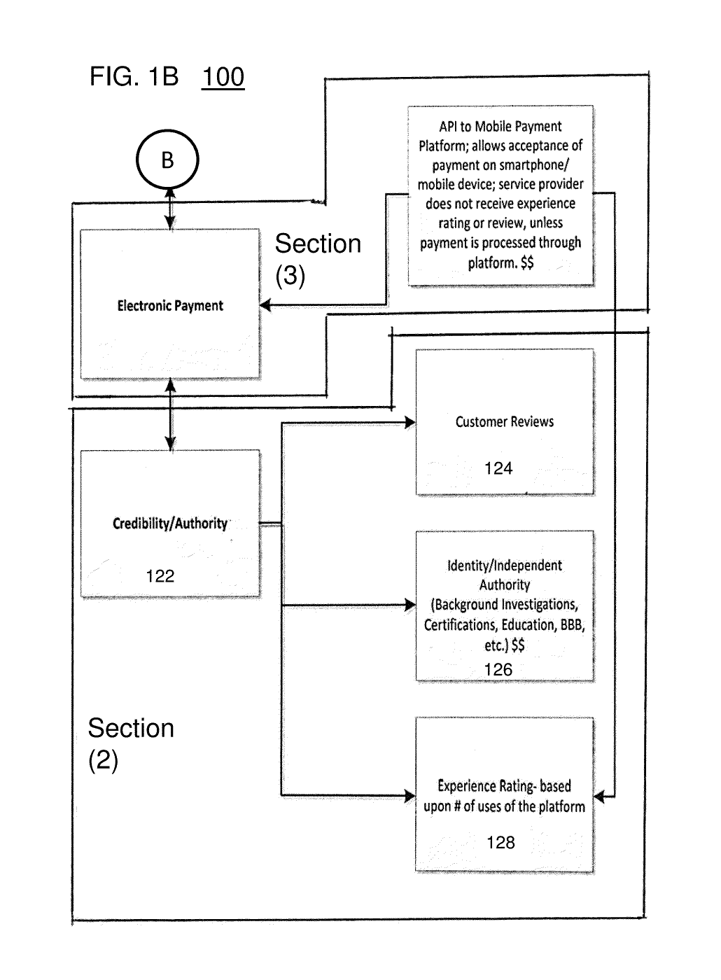

Turning now to FIGS. 1A and 1B, the operation of and organization of a platform in accordance with the various embodiments is illustrated. Referring first to Section (1) of the chart, showing an account scheduling portion, mobile service providers (102) subscribe or otherwise create an account with the platform and authorize the platform to track their real-time GPS location using a mobile phone, for example. The provider can have one of various types of accounts (e.g., Simple 108, Extended 110, Advanced 112), where each type of account is associated with different capabilities with respect to notifying end users of present and future availability, as well as different levels of integration with applications at a provider's mobile device, as shown in FIG. IA. Therefore, the service may be a free service to both potential customers and also providers that respond to real-time offers for service. If a provider desires to use the platform to enhance advertising opportunities, a different cost structure can be made available to permit the provider to control future scheduling, and even of its employees.

A scheduling system 114 can also receive service class/subclass information 116, exact service information 118, and/or event information 120. Additionally, scheduling and availability information can be received at system 114.

Still referring to Section (1), when a potential customer submits a request for a service, the web-based service obtains either (1) a location (104) of the potential customer (i.e., shopping center) and/or (2) a location (106) that service will be performed (i.e., home/business). The location associated with the potential customer may be obtained through a mobile phone GPS or an address associated with the customer as applicable. Similarly, scheduling and appointment information can be received.

Referring now to Section (2) shown in FIG. 1B, the platform, upon receipt of a request from a customer, can use information therein to identify a list of qualified contractors for the requested service using selected criteria and presents the list to the potential customer. The web-based service may rank the list of qualified contractors according to credibility/authority criteria (122). For example, the qualified contractors may be given a higher score for positive customer reviews and a lower score for negative customer reviews (124). For example, the qualified contractors may be given a higher score for attaining service-related certifications/peer recognition or passing background screening/drug tests, i.e., recognition and evaluation by independent sources (126). By contrast, the qualified contractors may be given a lower score or excluded from participating in the service based on negative authority. Additionally, the web-based service may rank the list of qualified contractors higher on the list for loyal contractors that frequently use the web-based service (128).

Referring now to Section (3) shown in FIG. 1B, the platform can includes an electronic payment component (130) that allows potential customer to pay directly through the platform. This expands payment options to credit card, mobile payment, direct transfer, and other options to guarantee the provider with payment. The customer reviews and experience rating described in Section (2) may be contingent on receiving payment through the platform.

Now that a general description of the various embodiments has been provided, the disclosure turns to a description of various software and hardware components for implementing the various embodiments.

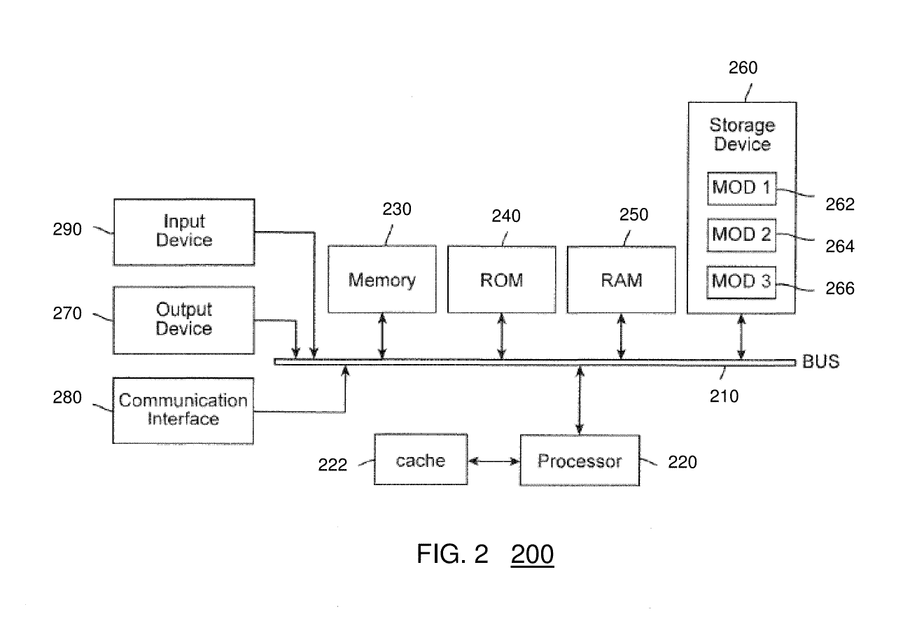

FIG. 2 illustrates an exemplary system 200 for implementing one or more aspects of the various embodiments. System 200 is a general-purpose computing device, including a processing unit (CPU or processor) 220 and a system bus 210 that couples various system components including the system memory 230, such as read only memory (ROM) 240, and random access memory (RAM) 250 to the processor 220. The system 200 can include a cache 222 of high speed memory connected directly with, in close proximity to, or integrated as part of the processor 220. The system 200 copies data from the memory 230 and/or the storage device 260 to the cache 222 for quick access by the processor 220. In this way, the cache 222 provides a performance boost that avoids processor 220 delays while waiting for data. These and other modules can control or be configured to control the processor 220 to perform various actions. Other system memory 230 may be available for use as well. The memory 230 can include multiple different types of memory with different performance characteristics. It can be appreciated that the disclosure may operate on a computing device 200 with more than one processor 220 or on a group or cluster of computing devices networked together to provide greater processing capability. The processor 220 can include any general purpose processor and a hardware module or software module, such as module 2 262, module 2 264, and module 3 266 stored in storage device 260, configured to control the processor 220 as well as a special-purpose processor where software instructions are incorporated into the actual processor design. The processor 220 may essentially be a completely self-contained computing system, containing multiple cores or processors, a bus, memory controller, cache, etc. A multi-core processor may be symmetric or asymmetric.

The system bus 210 may be any of several types of bus structures including a memory bus or memory controller, a peripheral bus, and a local bus using any of a variety of bus architectures. A basic input/output (BIOS) stored in ROM 240 or the like, may provide the basic routine that helps to transfer information between elements within the computing device 200, such as during start-up. The computing device 200 further includes storage devices 260 such as a hard disk drive, a magnetic disk drive, an optical disk drive, tape drive or the like. The storage device 260 can include software modules 262, 264, 266 for controlling the processor 220. Other hardware or software modules are contemplated. The storage device 260 is connected to the system bus 210 by a drive interface. The drives and the associated computer-readable storage media provide nonvolatile storage of computer readable instructions, data structures, program modules and other data for the computing device 200. In one aspect, a hardware module that performs a particular function includes the software component stored in a non-transitory computer-readable medium in connection with the necessary hardware components, such as the processor 220, bus 210, display 270, and so forth, to carry out the function. The basic components are known to those of skill in the art and appropriate variations are contemplated depending on the type of device, such as whether the device 200 is a small, handheld computing device, a desktop computer, or a computer server.

Although the exemplary embodiment described herein employs a hard disk as storage device 260, it should be appreciated by those skilled in the art that other types of computer-readable media which can store data that are accessible by a computer, such as magnetic cassettes, flash memory cards, digital versatile disks, cartridges, random access memories (RAMs) 250, read only memory (ROM) 240, a cable or wireless signal containing a bit stream and the like, may also be used in the exemplary operating environment. Non-transitory computer-readable storage media expressly exclude media such as energy, carrier signals, electromagnetic waves, and signals per se.

To enable user interaction with the computing device 200, an input device 290 represents any number of input mechanisms, such as a microphone for speech, a touch-sensitive screen for gesture or graphical input, keyboard, mouse, motion input, speech and so forth. An output device 270 can also be one or more of a number of output mechanisms known to those of skill in the art. In some instances, multimodal systems enable a user to provide multiple types of input to communicate with the computing device 200. The communications interface 280 generally governs and manages the user input and system output. There is no restriction on operating on any particular hardware arrangement and therefore the basic features here may easily be substituted for improved hardware or firmware arrangements as they are developed.

For clarity of explanation, the illustrative system embodiment is presented as including individual functional blocks including functional blocks labeled as a “processor” or processor 220. The functions these blocks represent may be provided through the use of either shared or dedicated hardware, including, but not limited to, hardware capable of executing software and hardware, such as a processor 220, that is purpose-built to operate as an equivalent to software executing on a general purpose processor. For example, the functions of one or more processors presented in FIG. 2 may be provided by a single shared processor or multiple processors. (Use of the term “processor” should not be construed to refer exclusively to hardware capable of executing software.) Illustrative embodiments may include microprocessor and/or digital signal processor (DSP) hardware, read-only memory (ROM) 240 for storing software performing the operations discussed below, and random access memory (RAM) 250 for storing results. Very large scale integration (VLSI) hardware embodiments, as well as custom VLSI circuitry in combination with a general purpose DSP circuit, may also be provided.

The logical operations of the various embodiments are implemented as: (1) a sequence of computer implemented steps, operations, or procedures running on a programmable circuit within a general use computer, (2) a sequence of computer implemented steps, operations, or procedures running on a specific-use programmable circuit; and/or (3) interconnected machine modules or program engines within the programmable circuits. The system 200 shown in FIG. 2 can practice all or part of the recited methods, can be a part of the recited systems, and/or can operate according to instructions in the recited non-transitory computer-readable storage media. Such logical operations can be implemented as modules configured to control the processor 220 to perform particular functions according to the programming of the module. For example, FIG. 2 illustrates three modules Mod1 262, Mod2 264 and Mod3 266, which are modules configured to control the processor 220. These modules may be stored on the storage device 260 and loaded into RAM 250 or memory 230 at runtime or may be stored as would be known in the art in other computer-readable memory locations.

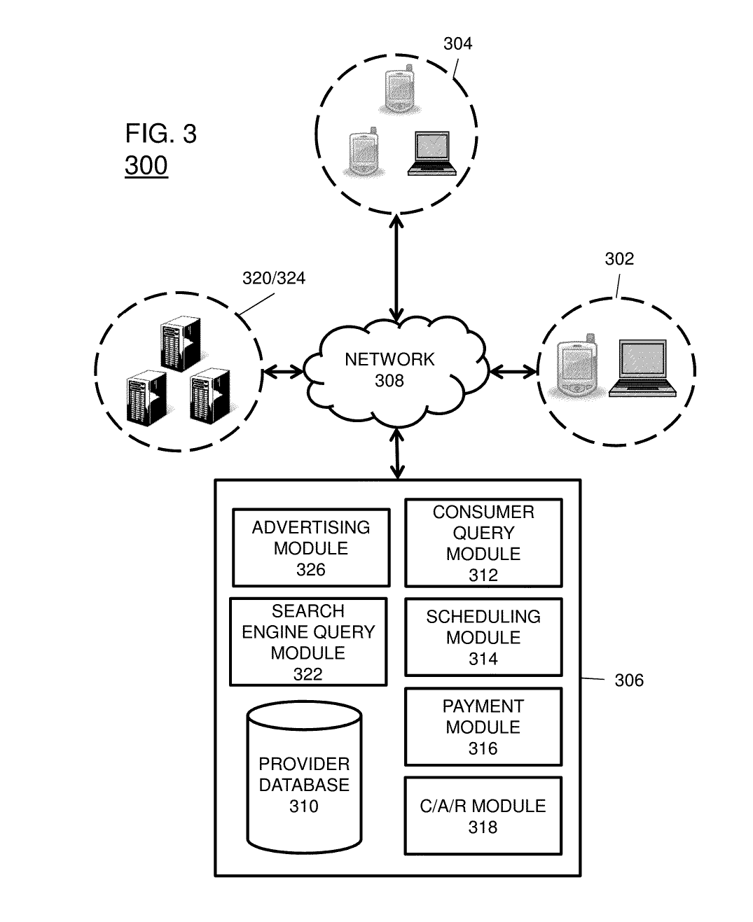

Having disclosed some components of a computing system, the disclosure now turns to FIG. 3, which illustrates an exemplary system configuration 300, wherein electronic devices communicate via a network for purposes of exchanging content and other data in accordance with the various embodiments. The system can be configured for use on a network as illustrated in FIG. 3. However, the present principles are applicable to a wide variety of network configurations that facilitate the intercommunication of electronic devices. For example, each of the components of system 300 in FIG. 3 can be implemented in a localized or distributed fashion in a network.

In system 300, the exchange of information between provider terminals 302₁ . . . 202ₙ (collectively “302”) and consumer terminals 304₁ . . . 304ₙ (collectively “304”) is performed via a management system 306, wherein the provider terminals 302, the consumer terminals 304, and the management system 306 are in direct or indirect communications via network 308.

Provider terminals 302 can be utilized to provide provider information and scheduling information to the management system. The provider terminals 302 can also be configured to receive appointment information associated with consumers, such as appointment time and location information, information regarding the consumer, information regarding the good and services requested by the consumer during the appointment, or any other information potentially relevant to the provider for the appointment. In some cases, the scheduling information can also be accompanied by payment or deposit information from consumers. As shown in FIG. 3, the provider terminals 302 can be mobile computing devices. However, the various embodiments are not limited in this regard and other types of computing devices can be utilized to implement provider terminals 302.

In the various embodiments, the scheduling information provided via provider terminals 302 includes at least availability information and location information for providers. That is, not only the dates and times that the provider is currently available for appointments or for which appointments are already booked, but also location information for such dates and times. The provider information can indicate the type of provider or any other type of information for identifying the provider to consumers. Optionally, the provider information can adjusted on a date/time/location basis. That is, the provider information can indicate how a provider is or will be outfitted or configured for a specific date, time, and location combination. For example, the provider information can associate a particular combination of services with specific combinations of dates, times, and locations. In another example, the provider information can indicate goods that will be available for delivery or purchase for specific combinations of dates, times, and locations.

The providers can provide such information in different ways via provider terminals 302. In some configurations, the provider terminals 302 can execute a local application configured to provide an interface for communicating with the management system 306. In other configurations, the provider terminals 302 can be utilized to access a remote application or website which serves as an interface for the management system 306. In yet other embodiments, a combination of local and remote applications can be utilized by the provider terminals 302 to provide access to the management system 306. In the various embodiments, the application can be configured to require a provider to register with the management system 306, either via the provider terminal 302 or other computing device.

In the various embodiments, the remote or local application can be configured in a variety of ways to allow the providers to communicate provider and scheduling information in a variety of ways. In one configuration, the application at the provider terminal 302 can be configured simply to allow the provider to input provider and scheduling information via a set of toggle switches, predefined selections, or other limited data entry. For example, the application can be a mobile device application configured with a toggle that allows a provider registered with the management system 306 to indicate whether or not the provider is currently available. In some cases, the provider can also provide a limited description of the goods or services available. The selection can then be combined with geo-location information obtained at the mobile device manually via the application or automatically, such as Global Positioning System (GPS) or network location information associated with the mobile device (including cellular and/or WiFi network location information), to forward at least the current scheduling information for the registered provider to the management system 306. In a second configuration, the remote or local application can be configured to allow greater control and options on the part of the provider. For example, the application at provider terminal 302 can be configured to include calendar functions to allow the provider to input current and future availability and location information, as well as to display appointments booked by consumers. Further, the application can be configured to integrate with a calendar application at the provider terminal 302.

The present disclosure contemplates that the communication of provider and scheduling information can occur as frequently or as infrequently as desired by the provider. That is, provider can contact the management system 306 at any time and provide the necessary updates. In some embodiments, this can be a manual process based on inputs provided by the provider. In other embodiments, this process can be automated. For example, as the provider makes changes in a local calendar, some or all of the changes can be processed by the management system 306 and cause the scheduling information to be adjusted. In another example, as the provider acquires tools, parts, or other items, the scheduling information for certain types of goods and services can be adjusted in accordance with these items. In this case, an inventory system associated with the provider can be coupled to the management system. In still another example, other changes, such as geographic locations, personnel, and current activities, can be detected at the provider's location and reported to the management system. Based on such changes, the provider information and scheduling information can be adjusted.

The present disclosure also contemplates that in some instances, the number and types of updates can be based on the provider's relationship with the management system. For example, in the case of providers who subscribe or pay a fee for an associated application, a greater number of different update capabilities can be provided. In contrast, a basic user may be able to perform only limited updates or may be required to always perform updates manually. However, the various embodiments are not limited to any particular configuration for performing updates of provider or scheduling information.

Additionally, the application can be configured to allow the provider to view payment information from consumers. Also, the application can be configured to allow the provider to view customer ratings, reviews, rankings, and other credibility information for the provider. In a third configuration, the remote or local application can be further configured to allow greater control and options on the part of the provider, particularly with respect to employees and agents of the provider. For example, the application can be configured to allow a supervisor to view or edit schedules for employees, agents, contractors, or the like.

Consumer terminals 304 can be utilized to exchange information with management system 306 or other elements in system 300 via network 308. As shown in FIG. 3, the consumer terminals 304 can be mobile computing devices. However, the various embodiments are not limited in this regard and other types of computing devices can be utilized to implement consumer terminals 304. The consumer terminals 304 can be configured to send various types of information, include query information or information for assembling a query, to the management system, directly or indirectly (i.e., via a third party system or application). This information can include preferred appointment times for the consumer, location information for providing the goods or services, information regarding the consumer, information regarding the good and services requested by the consumer during the appointment, or any other information potentially relevant to the provider for an appointment.

The consumers can provide such information in different ways via consumer terminals 304. In some configurations, the consumer terminals 304 can execute a local application configured to provide an interface for communicating with the management system 306. In other configurations, the consumer terminals 304 can be utilized to access a remote application or website which serves as an interface for the management system 306. In yet other embodiments, a combination of local and remote applications can be utilized by the consumer terminals 304 to provide access to the management system 306. In still other configurations, the application may be a third party application that interfaces with the management system 306. In some embodiments, the application can be configured to require a consumer to register with the management system 306, either via the consumer terminal 304 or other computing device. However, in other embodiments, no registration may be required.

In the various embodiments, the remote or local application can be configured in a variety of ways to allow the consumer to interact with management system 306 in a variety of ways to allow consumers to search for and book appointments with providers. In one configuration, the application at the consumer terminal 304 can be configured as a simple search application, with sets of toggle switches, predefined selections, or other limited data entry. For example, the application can be a mobile device application configured with a set of pre-defined criteria for the consumer to select from to assemble the information to be forwarded to management system 306. In some cases, the application can be configured to perform key word or other more complex search types. The consumer's inputs can then be combined with geo-location information obtained at the mobile device, manually, via the application, or automatically, such as Global Positioning System (GPS) or network location information associated with the mobile device, to forward a query to the management system 306. The application can also be configured to receive results from the query and allow the consumer to refine the query or make a selection of an appointment time for a provider.

In some embodiments, the remote or local application can be configured to allow greater control and options on the part of the consumer. For example, the application at consumer terminal 304 can be configured to include calendar functions to allow the consumer to add appointment information to a calendar application, alarm or notification application, or a messaging application at the consumer terminal 304. Additionally, the application can be configured to allow the consumer to provide payment information, either via the management system 306 or via a third party payment system associated with the selected provider. Also, the application can be configured to allow the consumer to submit customer ratings, reviews, rankings, and other credibility information.

Management system 306 is utilized to manage interactions between providers and consumers. In FIG. 3, management system 306 is illustrated as consisting of a particular set of modules, components, and elements. However, this is solely for illustrative purposes. In the various embodiments, a management system can include more or less components than illustrated in FIG. 3. Further, the modules, components, and elements of a management system in accordance with the various embodiments can be implemented in a local or distributed fashion.

As shown in FIG. 3, the management system 306 can include a provider database 310. In the provider database 310 can be stored provider information and scheduling information generated at the provider terminals 302, as discussed above. The present disclosure also contemplates that the management system 306 would include processing and data storage resources associated with provider database 310 for manipulating, adjusting, formatting, or organizing information received in a variety of ways. For example, the provider database 310 can be configured so that information is stored in provider database 310 according to a specific format, regardless of the source of the information, to facilitate data accesses at the provider database 310. The present disclosure also contemplates that provider database can also consist of several storage elements and not a single database, as illustrated in FIG. 3.

The management system 306 can further include a consumer query module 312 for managing requests from consumer terminals 304. In some embodiments, the consumer query module can be configured for receiving a set of information from the consumer terminals 304 and assemble a query to submit to provider database 310. In other embodiments, the consumer query module can be configured to expect information, already formatted as a query. In such embodiments, the consumer query module 312 can be configured to check the input query to see if it is valid and take appropriate action. In the case the query is valid, the consumer query module 312 can forward the query to the provider database 310 for processing. In the case the query is invalid, the consumer query module 312 can generate an error message for the consumer terminal 304 associated with the query or can optionally assemble a valid query based on a set of rules. For example, if particular types of data are required for certain types of queries, the error message can be configured to communicate the need for such particular types of queries.

Regardless of how the query is generated, the consumer query module 312 can interact with the provider database 310 to retrieve relevant data for the query. That is, data associated with providers that match the criteria set forth by the query from the consumer terminal 304. In some embodiments, the searching of the provider database 310 can be performed directly by the consumer query module 312. However, the present disclosure also contemplates that the provider database 310 can include additional components for performing the search and forwarding the results to the consumer query module 312.

In response to receiving the data from the provider database 310, the consumer query module 312 can be configured to provide the data to the consumer terminals 304 in a variety of ways. In some embodiments, the consumer query module 312 can forward the raw data to the consumer terminals 304 and the consumer terminals 304 can format the raw data appropriately. In other embodiments, the consumer query module 312 can process the data received from the data processing module 310 prior to delivery to the consumer terminals 304. For example, the consumer query module 312 can be configured for altering or adjusting the data to account for application type, device type, or network connection type prior to delivery of the data to the consumer terminal. Alternatively or in combination with such altering or adjusting, the consumer query module 312 can also organize the data based on location, cost, ranking, or any other criteria. In the case where the consumer query module 312 forwards raw data, the present disclosure contemplates that the provider terminals 304 can perform the aforementioned operations instead.

The management system 306 can further include a scheduling module 314. The scheduling module 314 can be configured, based on selections at the consumer terminals 304 to schedule or book an appointment for a consumer and provider at a specific time and at a specific location. In operation, the scheduling module 314 can receive the selections from the consumer terminal 304 indicating a consumer's desired appointment. The scheduling module 314 can then verify whether the selection is still valid based on the current information in the provider database 310. Thereafter, if the appointment time is still available, the scheduling module can confirm the appointment with the requesting one of consumer terminals 304. Concurrently, the scheduling module 314 can update the provider database 310 based on the booked appointment. Further, the scheduling module 314 can also update the one of provider terminals 302 associated with the appointment. In the various embodiments, updates can be automatically triggered by a request from the scheduling module 314 or can be triggered automatically whenever the provider database 310 detects a change. In some embodiments, the updates to the provider terminals 302 can be provided immediately, especially when the requested time is in the immediate future. However, the present disclosure also contemplates that updates to provider terminals can be provided on a scheduled basis, an on-demand basis, or a combination of methods. For example, urgent or immediate appointment information can be forwarded immediately and other appointment information can be forwarded at a later time.

The management system can also include a payment module 316. The payment module 316 can be utilized to receive and process payments from consumers, either before or after the exchange of goods or services. In some embodiments, the provider can require that a consumer pre-pay or provide a deposit prior to completing booking of an appointment time. Accordingly, upon the scheduling module 314 receiving a selection of an appointment from the consumer terminals 304 requiring payment, the scheduling module 314 can invoke the payment module 316. In the various embodiments, the payment module 316 can operate in a variety of ways. In one configuration, the payment module 316 can initiate a direct interaction with the requesting one of the consumer terminals 304 and complete the payment process. In another configuration, the payment module 316 can cause the one of the consumer terminals to interact with a third party payment platform (not shown) and await confirmation of payment from the third party payment platform. For example, the payment module 316 can be configured to utilize the PAYPAL service provided by eBay Inc. of Palo Alto, Calif. Regardless of the payment method, once the payment is provided, the payment module 316 can signal the scheduling module 314 to complete the booking and update schedules accordingly. In some embodiments, the scheduling module 314 can complete a booking without payment or can provide a consumer a deadline, prior to the appointment time, for submission of payment. Thereafter, unless the scheduling module 314 receives confirmation from the payment module 316, the scheduling module can cancel the appointment.

The management system can further include a credibility/authority/review (C/A/R) module 318. The C/A/R module 318 can be utilized to collect and assemble C/A/R information regarding experience points, ratings, reviews, or and rankings regarding the providers associated with the management system 306. This information can be added by the C/A/R module 318 to the provider database 310. Thus, when the consumer query module 312 accesses the provider database 310, the consumer query module 312 can provide the C/A/R information to the consumers along with the other provider information. In some embodiments, the C/A/R module 318 can be configured to receive updates to the C/A/R information either from consumer terminals 304 or other sources. For example, the C/A/R module 318 can be configured to mine C/A/R information from websites or other databases. In another example, as described above, experience points can be added to the C/A/R information upon completion of a transaction, i.e., after a payment is made.

In some embodiments, the C/A/R module 318 can be configured to provide a relative ranking of providers registered with the management system 306 that can be added to the provider database 310 or can be utilized by the consumer query module 312 when responding to queries. However, the various embodiments are not limited in this regard and the C/A/R module can be configured to obtain ranking information from external sources.

The present disclosure additionally contemplates that direct access to the management system 306 is but one way for the consumer terminals 302 to access information from the provider database. In some embodiments, the management system 306 can be utilized as a source of search results or advertisements on other portals. For example, in one particular embodiment, the management system 306 can be configured to interface with a search engine 320 or an advertisement server 324.

In the case of the search engine 320, a consumer terminal 304 can submit a query for good and services in a local area. In response to receiving such a query, the search engine 322 can submit a query to a search engine query module 322 of the management system 306. The search engine query module 322 can operate in a substantially similar fashion as the consumer query module 312. In response to such a query, the search engine query module can provide results, raw or processed, to the search engine 320. Such results would be substantially similar to those provided if a consumer terminal 304 submitted the query directly to the management system 306. Additionally, the result can include links or instructions to leading a provider to a portal for the management system 306. The search engine can then process the results as needed and deliver the results to the consumer terminal 304. Should a consumer at the consumer terminal 304 select a search result associated with a provider and obtained from the management system 306, links to the portal can be presented to the consumer at the consumer terminal. Selection of such links can then direct the consumer to a portal page to schedule an appointment with the provider. Alternatively, the selection of a provider from the search results can automatically redirect the consumer to the portal page for scheduling the appointment. In some embodiments, when a consumer is redirected to the portal associated with the management system 306, the management system can display not only information associated with the provider selected via the search result, but also information for other providers associated with similar information. At this point, processing of the consumer selections and booking of an appointment is managed as previously described.

In some embodiments, the management system 306 can also serve as a source of advertisements for an advertisement server 324 or any other platform serving advertisements to consumers at consumer terminals 304. In particular, the management system 306 can include an advertising module 326. The advertising module can be configured to generate content for advertisements based on the provider information and the scheduling information obtained from the providers. In one exemplary configuration, the advertisement server 326 can send a request to the management system 306 to provide an advertisement based on the characteristics of the consumer to which the advertisement is to be delivered. These can include at least subject matter and location characteristics. These characteristics can then be used by the advertising module to obtain provider data from the provider database 310 in a manner similar to that described for the consumer query module 312 and the search engine query module 322.

The configuration of FIG. 3 is provided for illustrative purposes and provides solely one exemplary embodiment. The present disclosure contemplates that the functions and features described above can be implemented using more or less components than illustrated in FIG. 3. Further, the present disclosure contemplates that the components of FIG. 3 and any variations thereof can be implemented in a localized or distributed manner.

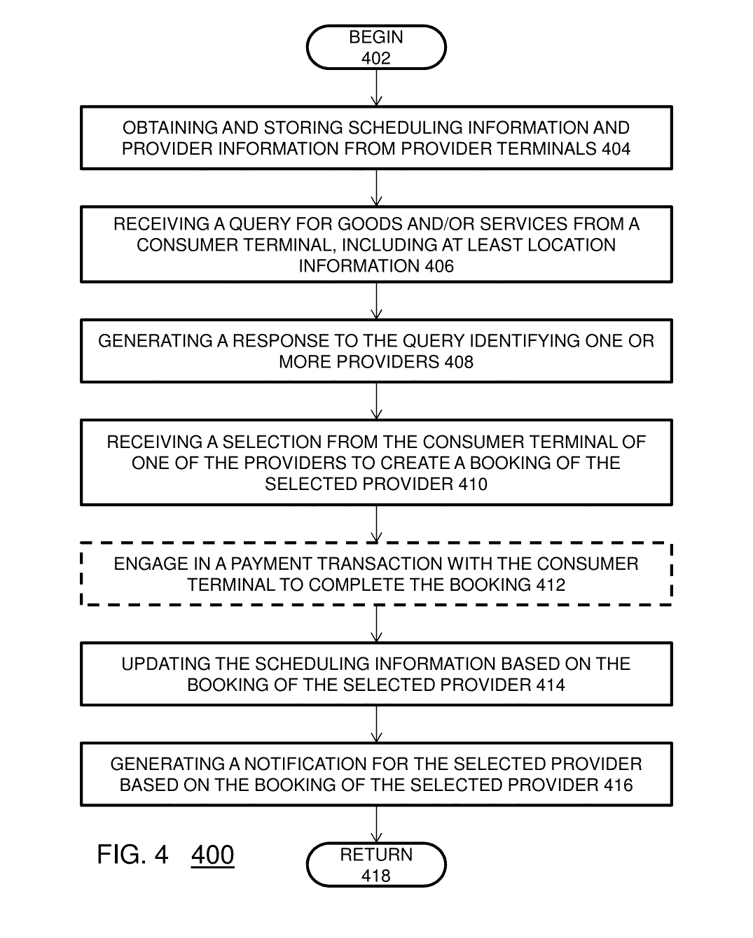

FIG. 4 is a flow chart of steps in an exemplary method 400 for processing queries in accordance with the various embodiments. Method 400 begins at step 402 and continues on to step 404. At step 404, the management system 406 receives or otherwise obtains provider data from providers 302, as described above. Before, after, or concurrently with step 402, the management system 306 receives a query from a consumer terminal 304 at step 406. As noted above, the query can include at least location information and goods or services being sought by the consumer. In some embodiments, GPS or network location information can provide the location information. In other embodiments, the location information may be part of a cookie or other data stored at the consumer terminal, which is then included in the query.

At step 408, the management system 306 can generate a response to the query at step 408. As noted above, this can encompass using a consumer query module 312 to access a provider database to identify data relevant for the response to the query. The generating of the response at step 408 can include ranking the identified providers according to pre-defined criteria or other criteria specified by the user. The criteria can be based on at least one of: a relative proximity to the requested location, a booking frequency associated the identified providers, user ratings associated the identified providers, cost ratings associated with the identified providers, and a type of the identified providers. However, the various embodiments are not limited in this regard and other criteria can be utilized as well. The response to the query can include, as discussed above, can indicate availability for one or more time blocks of one or more providers matching the criteria.

After the query results are provided to the consumer terminal 304 at step 408, a selection of a provider and a time can be communicated by the consumer at step 410. For example, the consumer can make a selection at consumer terminal 304 of a provider and a time block and communicate the selection to the scheduling model 314 of management system 306.

In some embodiments, the selection at 410 may require payment of a fee or deposit to complete a booking of the selected provider at the desired time. Therefore, at step 412, the payment module 316 of management system 306 can engage directly with the consumer terminal to complete a payment transaction to cover the fee or deposit. Alternatively, the consumer can pay via a third party and have the payment information forwarded to the payment module 316, which in turn can authorize completion of the booking of the provider.

Regardless of whether payment is required or not, the scheduling module 314, as described above, can update a schedule associated with the selected provider at step 414. For example, the scheduling module 314 can update the provider database 310. Thereafter, at step 416, a notification can be generated for the selected provider. As previously noted, such notification can be provided immediately or on a scheduled basis. Finally, the method 400 can proceed to step 418 and resume previous processing, including repeating method 400.

Although the foregoing description addresses the basic framework of the various embodiments, the present disclosure contemplates various modifications and improvements to this basic framework can be provided in the various embodiments.

Dynamic Scheduling & Adherence

Although a provider can indicate general availability during a block of time, this may not necessarily describe actual availability of a provider for a customer. For example, in the case of service personnel, the general availability may not consider scheduled breaks and pre-defined lead times (i.e., built-in buffers between appointments, not including transit time). The general availability also may not consider estimated service time based upon service complexity or type of service needed by the customer. The general availability may also not consider transit time to a service location or transit time to obtain any tools or part needed for the service location. Further, the general availability may also not consider transit time to a next service location. In other words, although a service provider may be available during a block of time, it does not follow that the service provider is available for a particular customer during that block of time, either in general or for performing specific tasks.

In view of the foregoing, the present disclosure contemplates that in some embodiments, the availability of providers can be adjusted, on a general basis, or a per-customer basis, or a combination of both. Thus, the customer seeking certain goods and services will actually be provided a more accurate indication of availability.

To this end, the present disclosure contemplates that in response to a customer query for providers of goods and services, a management system can adjust the availability reported by providers to account for any factors that might limit actual availability for the customer. For example, in some embodiments, the management system can utilize pre-defined service times for various services and adjust availability accordingly. The management system can also calculate transit times by calculating drive time between service provider and user location, optionally adding transit time to service destination (ie, pickup location), and adjust the availability accordingly. In some cases, the service times, lead times, transit times, or any other sources of adjustments can be predefined at the management system for all providers. However, the various embodiments are not limited in this regard. Rather, in some instances a provider can define some or all of the types and amounts of adjustments needed.

As part of returning query results to the customer, the management system can compare the estimated total job time to the service provider's scheduled availability and return a warning flag for those service providers who may have a potential schedule conflict based upon the total job time (as calculated above). However, the present disclosure contemplates that in some instances, a customer may attempt to book a service provider knowing that the provider has insufficient time to complete the service at the service location. For example, if a customer believes that the estimated service time is longer than what is needed, then user may still select service provider. However, to protect the reputation of service providers, the management system can be configured so that the service provider will not receive negative experience for denying a service request or having to leave the service location early.

Whether a warning flag is raised or not, once a request is accepted by the provider, the provider's calendar will be dynamically updated with the total job time, thus preventing duplicate or conflicting bookings and insuring higher degrees of accuracy on the calendar, to the benefit of potential customer.

In some embodiments, geofencing can be incorporated to mark the date and time that service providers enter certain geographic or location areas in the provision of services or upon exiting after provision of services. Such information can be utilized for reporting purposes and to refine and/or customize estimated service times, and thus provider availability. Likewise, the time and date stamps can be used for verifying schedule adherence and providing an objective quality control aspect to the provision of services, to the customer's benefit. For example, the management system can utilized geofencing to automatically know whether the service provider was on time; this is yet another piece of data that can be used as a metric for the ranking of service providers: on-time %. In some embodiments, one can re-use geofencing capabilities that are already established by other entities as a service. In other embodiments, the management system can have its own geofencing capabilities.

To further streamline schedule adjustments and ensure accurate availability times, the management system can interface with a mapping app on the mobile device to give the provider directions. Optionally, depending on the context of the service, the service provider can share real time location information with the user. This could be instead of or in addition to the aforementioned geofencing. This could be another optional module for service providers provided by an API for GPS/mapping software. However, the various embodiments are not limited in this regard and traditional navigation can be provided, i.e., where users would have to enter addresses to a service location manually.

Geographic Availability Scheduling

In much the way that customers can define service provision based upon location and time, the present disclosure contemplates that providers can do so as well in some embodiments. That is, providers can define schedule/calendar visibility based upon geographic and time criteria. For example, a service provider might determine that he or she will only provide services within a defined area of a city on a defined day of the week. For mobile food trucks, the benefit is obvious, but for other scheduled service providers, it could allow for greater logistical efficiency and improved profits over time. While this concept may be of limited benefit to newer businesses or those in smaller cities, service providers with busy schedules or service providers in larger metropolitan areas could benefit from establishing predetermined service areas and service times, from within which services can be scheduled by users. Alternatively, if a service provider broadcasts location/schedule information in advance, it may actually alter the user behavior to wait and obtain services when the service provider will already be in the neighborhood.

In such embodiments, providers define customizable geographic areas (by zip code, neighborhood, city, county, state, region, etc.) along with various windows of time to create geo-time slots. The geo-time slots would then be assigned to the provider's calendar as a filter for receiving service requests. Additionally, the geo-time slots could act as a visibility mask, depending upon the provider's desire for visibility geographically.

In some embodiments, the management system can warn service providers of potential conflicts between their current location and scheduled future location based upon transit time in order to enable schedule adherence. Alternatively, or in addition, the provider's calendar could automatically indicate that he or she is unavailable until the service provider enters the predefined geographic area.

Cancellations/Auto Reschedule/Dispute/Acceptance

As noted above, one aspect of the various embodiments is the rating of providers and taking certain actions based on ratings. One aspect is satisfaction with the level of service provided by the provider. However, in some embodiments, the scheduling process can also affect ratings. For example, the management system can track acceptance or cancellation rates. Therefore if service providers that show schedule availability, but do not accept requests or otherwise fail to fulfill requests, they will have a low acceptance % or high cancellation count, and the management system can negatively affects their ranking or ratings.

The present disclosure also contemplates that the generation of ratings based on cancellation rates or low acceptance rates can also be customized for different providers. For example, service providers could be associated with the management system based on a subscription level and ratings can be affected based on the subscription level. That is, service providers with a premium subscription could be allotted x number of no-penalty (without adversely affecting ratings) emergency cancellations (defined as cancellation within x time of scheduled service provision) per time period. In contrast, non-premium service providers would not receive such allowances and all cancellations would go into the feedback statistics. A similar scheme can be provided for acceptance rates.

In some embodiments, upon the occurrence of a cancellation event, such cancellations could allow for automatic rescheduling suggestions, either initiated by the user or service provider. The availability of such a rescheduling service can also be used to adjust ratings and rankings. Further, this can also be part of a subscription level.

In some embodiments, providers can be allowed to potentially dispute negative reviews or have them removed. This can also be based, optionally, on a subscription level.

Another aspect of cancellations or rescheduling can be credit. In some embodiments, providers providing goods and services on credit (with permission from user as appropriate) will be able to pay for credit score data and reject requests from users with insufficient credit, manually or automatically and before or after booking of a time slot. These services can be provided via the management system. In such cases, the present disclosure contemplates that in the event of a poor credit score causing the provider to decline or cancel an appointment, such reasons are recognized by the management system and the management system is configured to limit the effect of such events on ratings or rankings.

Masking

As part of the process of introducing customers to providers and vice versa, there are issues of privacy and security that need to be addressed depending on the context of the embodiment. Depending on how public the overall embodiment of the platform is and the nature of the service provided, the more safety and security precautions needed to qualify bonafide customers and providers. In one embodiment, this can be achieved via a paid user system. The reasoning behind this is that in a more restrictive embodiment in which membership or access to the platform is limited, user and service provider registration is a necessary prerequisite to participation and therefore more is known about the identities of everyone. On the other hand, in the case of a search engine or social network's use of data from the platform, any user can search, including those that are not legitimate. To protect from such circumstances, masking or concealing, of the exact location and/or identity of the service provider and/or user may be necessary. The exact location of a service provider may need to be masked completely, depending on the context.

As a further security precaution, anonymous scheduling, either on the part of the customer or provider, can be prohibited. Further, service providers should be able to define rules and exclude certain specific users from seeing their exact location, should they choose to make it available. The present disclosure also contemplates that a privacy policy can be provided and strictly enforced, defining API's that allow service providers to define the circumstances in which various types of information regarding location and identity are shared.

User Accounts/Identity/Service Provider Profiles

The present disclosure also contemplates that user and service provider accounts and identities can be enhanced and/or linked to existing sources of credible user account information to (1) provide an additional source of identity verification and (2) as a convenience to account holders. Entities with large existing user bases with API linked accounts such as large social networks or large goods and services providers could link their user accounts to the management system for single source logins, as applicable. Using similar technology, customers can share highly rated service providers over their social network based upon various criteria. Likewise, service providers can use social networks as an additional advertising platform. In this way, the customer defined search criteria in one embodiment may incorporate a social media aspect in which a customer would be able to see the similar service providers their friends are using. Further, there could be a further refinement of the experience rating, in which the results are presented in terms of a total friends experience rating, i.e., service providers that a user's friends use the most could rank highest. On the other hand, depending on an individual customer's privacy settings, he or she could share experiences with various service providers, thus allowing an individual customer to look up the service providers recommended by a specific friend/user who may hold a high level of credibility when it comes to recommending purchases of goods or services. Individually or collectively, customers in a social network could alter the ranking of search results based upon the importance that such customers give to social networking and create data feeds into social networks via API's.

In some embodiments, the database of providers profile information can be available and presented in HTML5, as an application and/or some hybrid of the two as appropriate. In this way, users can view provider profile information, goods and services provided, experience, education, geographic service area(s), upcoming calendar availability, masked location, rates, collaboration goods, services, events, etc. Users can also view order history and associated provider information. However, providers will have access to limited or extended user profile information as part of the iterative process of accepting/evaluating a service request.

Relationship Between Goods, Services and Events

The present disclosure also contemplates that in some cases, a customer may not be fully aware of all the goods and services associated with a request. This includes necessary and optional goods and services. For example, in the case of a customer searching for someone to perform painting services, it may not be sufficient to locate a painter. Rather, paint delivery, by a third party, may be required or special equipment may be required for the job. Further, the customer may also not realize that washing the exterior of the house is preferred prior to painting, a process also performed by a third party. Thus, the present disclosure contemplates recognizing these issues and adjusting availability or making suggestions based on such relationships.

Accordingly, in some embodiments, the management system is capable of associating good(s) with a service(s), service(s) with a good(s), and event(s) with good(s) and/or service(s) to identify or suggest additional goods and services required for a request. Further, in some embodiments, the management system is configured to allow for more than one service provider to collaborate or share in newly defined request for goods, services and/or an event, while maintaining granularity with respect to roles, performance (reviews), and payment.

In such embodiments, this can be accomplished by varying ability of providers to define what, if any, levels of collaboration they will participate in and to that extent (do they collaborate with other providers at all), what types of providers they will interact with (qualify other providers, i.e., insurance, licensing/bonding, education, experience, etc.), and documentation and confirmation of various types (user signature, delivery confirmation, bills of lading, etc.) required for certain types of relationships. However, is it contemplated that the customer will generally understand or will be notified that independent service providers are responsible for handling various aspects of the provision of a chain of services and that items like insurance can help bridge the gap in these instances.

Using such relationships can allow an unprecedented level of orchestration between independent contractors (providers). For example, an Event might have one or more Good types (food vendors) and therefore Menus and therefore menu items associated with it. A Good might have a Service type (delivery) and rate (free) associated with it. A Service might have a Good type (paint) associated with the provision of the service, i.e., painting a house. The platform would allow service providers to enter in the cost of goods and allocate lump sums, or specific amounts of inventory to certain jobs; such amounts could be itemized or rolled into the overall charge; pricing is ultimately in the service provider's discretion; this could also be an integration point to inventory and or financial accounting software.

Ultimately, the service provider or providers for different classes of goods, services and events can collaborate with these cross functional relationships to provide various end to end services. For example, if an ecommerce or mobile commerce site offers goods and classifies those goods in a way that semantically complies with the standards of the platform, then a second provider, also using the platform can collaborate and provide local delivery services in response to the customer interacting with the first service provider's site. In practice, when the page containing the good for sale is loaded, a request will be sent to the management server for, in this case, a delivery/courier request originating at the first service provider's address an ending and ending at the customer's address. Based upon the schedules of second service providers and their response to the requested service (as defined by the good itself (i.e., size, weight and other attributes), rates (per mile) will be returned along with an estimated delivery time. Ultimately, in such service provider collaboration, the service provider with the originating user request is able to define the criteria for associated goods, service and/or event service providers that will be eligible to receive the user request. Alternatively, the first service provider, by disclaiming any relationship with the second service provider, could offer the user the ability to select additional related service providers solely per the user's criteria. Based upon the definition of the cross-functional relationship, the customer would see in his or her account history a single order with two lines and two separate service providers with two separate charges: one for the goods and one for the delivery service.

In some embodiments, providers can qualify and “book” other service providers calendars/availability and offer customers a complete end to end solution. For example, a service provider of the event type could request food trucks (goods) on a specific date and time range on the food truck service provider's calendar. Once confirmed, the event service provider would be able to include the bundle of food truck service providers as part of the event. In this way, we have combined a single event type with multiple goods in order to create a new cross functional semantical relationship defined as the “food truck event,” in which the event is the parent of the hierarchy and the goods providers are on the next level underneath and the menus are under the next level. Although not previously stated, all logical and (custom defined) semantical relationships for goods and service and event types should be assumed (i.e., food truck name, cuisine(s), description, menu, menu section, item name, item description, item ingredients, item allergens, price, specials, etc.). It should be also assumed that any of these attributes could be potentially queried by the users and the system would return the associated providers.

In the previous example, it is contemplated that not only will the event be broadcast via the management system, but the individual service providers will provide proximity based virtual road map through the event along with electronic descriptions of goods (menus) and electronic payment options.

In some embodiments, the event provider can even define the terms of payment for the participating service providers (i.e., flat fee, % of revenue, free, etc.), providing a mechanism for peer to peer provider payment and collection, another source of revenue for the platform. In such a situation, because the event provider booked the calendar of the food truck service providers, the accepted payment terms dictate the acceptance of payment from users during that date and time; in other words, food truck service providers cannot bypass payment of the food truck event because payment is defined by the cross functional relationship that was created “food truck event,” and that is the model that the food truck will be operating within during that date and time. Once outside of that date and time, the typical service provider's model of food truck (good) provider will reinstate automatically, until such time the food truck decides to collaborate in another cross functional model. Thus, the current model drives and can override pricing and other attributes and is defined on the originating provider's calendar.

In some embodiments, when customers search for a provider, they will be able to see if a provider is acting independently at the moment or whether he or she is collaborating. If the service provider is collaborating, the user can have the option of being taken to the collaborating service provider (parent or sister) in the hierarchy. To reiterate, it is possible that a single provider acts in multiple roles to offers goods, services and or events; it is therefore possible for a food truck owner to create the food truck event and invite other food truck owners to participate; in this model, a cross-functional model is created in which the sister (event) is also a service provider of goods, and in which other service providers of goods are included equally in the event; such an event would be more collaborative in nature and might not, for example, include the parent level payment setting overrides as in the previous example.

Payment Services

In some embodiments, as described above, the management system can integrate with mobile retail based payment solutions in order to facilitate scanning a physical credit card and allowing user to sign service providers tablet or smartphone and have a receipt emailed to them.

In the case of an item that is pre-purchased through the management system, a customer could show his or her smartphone or tablet and the corresponding receipt (with barcode/QR Code, etc. and/or confirmation) in order to redeem and receive pre-purchased goods or services. In this way, customers could pre-pay for tickets for an event and use the electronic receipt for admission. Similarly, in the case of a food truck, customers can buy menu items on their smartphone while in line and pay for it. Upon arriving at order counter, the customer can simply read off their order from the smartphone and give service provider a confirmation/transaction number and a transaction total. Thereafter, the provider can matchup payment information and deliver the items. In the example where the receipt is utilized as a form of electronic ticket, the provider's mobile device or a dedicated barcode scanner code be utilized to scan the digital receipt and query the management server to verify that it is a valid receipt and return the result to either the service provider's mobile device or barcode scanner.

Live Feed

In some embodiments, providers can update their profile with a current picture or video at their location, along with directions/description of their address/location. API's to social networks can be used then by service providers to share their service, goods and/or event feeds.

In addition, pictures or video may be associated with services, goods and/or events. For example, a simple status update on a social network can be provided in which service providers can communicate additional time stamped information relevant to their services (“we'll be back next week!”), goods (“we′re running low on burgers, but we've got plenty of Nathan's hot dogs!”) or events (“Looks like it's starting to rain . . . hopefully it will blow over soon”)

This live feed type data can be helpful in communicating the very latest information and/or supplementing existing technical information with human derived information. For example, if a service provider is at an event in a park, the live feed could be used to describe exactly where the service provider is without having to rely on ultra-accurate location technologies. In this way, location based services can be supplemented with human directions and insight, even overriding the necessity for the functioning of location based systems in certain applications.

While various embodiments of the present invention have been described above, it should be understood that they have been presented by way of example only, and not limitation. Numerous changes to the disclosed embodiments can be made in accordance with the disclosure herein without departing from the spirit or scope of the invention. Thus, the breadth and scope of the present invention should not be limited by any of the above described embodiments. Rather, the scope of the invention should be defined in accordance with the following claims and their equivalents.

Although the invention has been illustrated and described with respect to one or more implementations, equivalent alterations and modifications will occur to others skilled in the art upon the reading and understanding of this specification and the annexed drawings. In addition, while a particular feature of the invention may have been disclosed with respect to only one of several implementations, such feature may be combined with one or more other features of the other implementations as may be desired and advantageous for any given or particular application.

The terminology used herein is for the purpose of describing particular embodiments only and is not intended to be limiting of the invention. As used herein, the singular forms “a”, “an” and “the” are intended to include the plural forms as well, unless the context clearly indicates otherwise. Furthermore, to the extent that the terms “including”, “includes”, “having”, “has”, “with”, or variants thereof are used in either the detailed description and/or the claims, such terms are intended to be inclusive in a manner similar to the term “comprising.”

Unless otherwise defined, all terms (including technical and scientific terms) used herein have the same meaning as commonly understood by one of ordinary skill in the art to which this invention belongs. It will be further understood that terms, such as those defined in commonly used dictionaries, should be interpreted as having a meaning that is consistent with their meaning in the context of the relevant art and will not be interpreted in an idealized or overly formal sense unless expressly so defined herein.

What is claimed is:

1. A method, comprising:
obtaining scheduling information and provider information associated with one or more providers, the scheduling information comprising availability information and location information associated with each of the providers for at least a portion of a plurality of time blocks, and the provider information comprising at least one of goods information or services information associated with each of the providers;
receiving a query associated with a consumer specifying at least one of a good or service to be provided to the consumer and a requested location for the providing of the at least one of the good or service; and
generating, based on the scheduling information, a response to the query, the response comprising:
an identification of a portion of the providers available to provide the good or the service at the location to yield identified providers, and
one or more times each of the identified providers is available to provide the good or the service at the location to yield identified times.

2. The method of claim 1, further comprising:
receiving, from a consumer user terminal associated with the consumer, a selection of one of the identified providers and one of the identified times associated with the one of the identified providers;
updating the scheduling information for the identified provider based on the received selection;
generating a message for a provider user terminal associated with the identified provider, the message indicating a booking of the identified provider at the one of the identified times.

3. The method of claim 2, wherein the method further comprises delivering to the first user terminal instructions for providing a payment required by the provider for confirming the booking based on the selection, and wherein the generating of the message is performed once receipt of the payment occurs.

4. The method of claim 1, wherein the at least one of the goods information and the service information is associated with particular one of the plurality of time blocks.

5. The method of claim 1, wherein the generating the response further comprises ranking the identified providers according to a pre-defined criteria.

6. The method of claim 5, wherein the pre-defined criteria is based on at least one of relative proximity to the requested location, a booking frequency associated the identified providers, user ratings associated the identified providers, cost ratings associated with the identified providers, and a type of the identified providers.

7. The method of claim 1, wherein the receiving comprises obtaining a query from a search engine being accessed by the consumer via a consumer terminal.

8. The method of claim 7, wherein at least a portion of the query is based on cookie information associated with the consumer terminal.

9. The method of claim 1, wherein at least a portion of the query is based on geolocation data stored at a consumer terminal associated with the consumer.

10. The method of claim 1, wherein the identifying of the portion of the providers comprises:
adjusting the scheduling information for each of the providers based on the query to yield adjusted scheduling information; and
selecting the portion of the providers based on the adjusted scheduling information.

11. The method of claim 10, wherein the adjusting comprises reducing the plurality of time blocks for each one of the providers based on at least one of a transit time between a current location of the one of the providers to the requested location, a transit time from the requested location to a next scheduled location for the one of the providers, scheduled breaks for the one of the providers, transit times associated with procuring items for providing the at least one of the good or the service at the requested location, or a geographic service area predefined by one of the providers.

12. The method of claim 1, wherein the identifying of the portion of the providers comprises determining at least one combination of said providers capable of providing the at least one of the good or the service at the requested location.

13. A system, comprising:
a memory for storing scheduling information and provider information associated with one or more providers, the scheduling information comprising availability information and location information associated with each of the providers for at least a portion of a plurality of time blocks, and the provider information comprising at least one of goods information or services information associated with each of the providers; and
at least processor communicatively coupled to the memory; and
a computer-readable medium having stored thereon a plurality of code sections for causing the at least one processor to perform the steps of:
receiving a query associated with a consumer specifying at least one of a good or service to be provided to the consumer and a requested location for the providing of the at least one of the good or service, and
generating, based on the scheduling information, a response to the query,
wherein the response comprises an identification of a portion of the providers available to provide the good or the service at the location to yield identified providers, and one or more times each of the identified providers is available to provide the good or the service at the location to yield identified times.

14. The system of claim 10, the computer-readable medium further comprising code sections for causing the at least one processor to perform the steps of:
receiving, from a consumer user terminal associated with the consumer, a selection of one of the identified providers and one of the identified times associated with the one of the identified providers;
updating the scheduling information for the identified provider based on the received selection;
generating a message for a provider user terminal associated with the identified provider, the message indicating a booking of the identified provider at the one of the identified times.

15. The system of claim 10, wherein the at least one of the goods information and the service information is associated with particular one of the plurality of time blocks.

16. The system of claim 10, wherein the generating the response further comprises ranking the identified providers according to a pre-defined criteria.

17. The system of claim 14, wherein the pre-defined criteria is based on at least one of relative proximity to the requested location, a booking frequency associated the identified providers, user ratings associated the identified providers, cost ratings associated with the identified providers, and a type of the identified providers.

18. The system of claim 1, wherein the receiving comprises obtaining a query from a search engine being accessed by the consumer via a consumer terminal.

19. The system of claim 1, wherein at least a portion of the query is based on geolocation data stored at a consumer terminal associated with the consumer.
